(19) United States
(12) Patent Application Publication
(10) Pub. No.: US 2023/0214447 A1
(43) Pub. Date: Jul. 6, 2023

(54) DATA PROCESSING APPARATUS, DATA PROCESSING METHOD, AND RECORDING MEDIUM

(71) Applicant: NEC Corporation, Minato-ku, Tokyo (JP)

(72) Inventors: Makoto TAKAMOTO, Tokyo (JP); Hiroshi FUKUI, Tokyo (JP)

(73) Assignee: NEC Corporation, Minato-ku, Tokyo (JP)

(21) Appl. No.: 18/009,080

(22) PCT Filed: Jun. 10, 2020
(86) PCT No.: PCT/JP2020/022844

§ 371 Date: Dec. 8, 2022

(51) Int. Cl. G06F 17/16

(52) U.S. Cl. CPC G06F 17/16

(57) ABSTRACT

A data processing apparatus (2) includes: a calculation unit (24) for calculating a map information (AP) that represents a distribution of a vector component having a relatively high importance of a plurality of feature vector components that are included in a fourth feature vector (z4) obtained by synthesizing a first feature vector (z1) and a second feature vector (z2); and a generation unit (23) for generating a third feature vector (z3) by using the fourth feature vector (z4) and the map information.

### TECHNICAL FIELD

The present disclosure relates to a technical field of a data processing apparatus, a data processing method and a recording medium that are configured to generate a feature vector.

### BACKGROUND ART

A Non-Patent Literature 1 discloses a method of performing a synthesis processing for synthesizing a plurality of feature vectors that represent features of a plurality types of data, respectively, and performing a desired arithmetic processing by using a feature vector generated by the synthesis processing (a method of performing a multi-modal processing).

Additionally, there are Patent Literatures 1 to 3 as a background art document relating to the present disclosure.

### CITATION LIST

### Patent Literature

Patent Literature 1: JP2019-536673A
Patent Literature 2: JP2018-078857A
Patent Literature 3: JP2007-265367A

### Non-Patent Literature

Non-Patent Literature 1: Tadas Baltrusaitis et al., “Multimodal Machine Learning: A survey and Taxonomy”, arxiv, 1705.09406, Aug. 1, 2017

### SUMMARY

### Technical Problem

The method disclosed in the Non-Patent Literature 1 performs the synthesis processing for simply adding the plurality of feature vectors (for example, adding them along a channel direction). Namely, the method disclosed in the Non-Patent Literature 1 synthesizes the plurality of feature vectors by always using same method without considering contents of the plurality of feature vectors. Thus, the method disclosed in the Non-Patent Literature 1 has such a technical problem that the plurality of feature vectors are not necessarily synthesized properly.

Moreover, there is a possibility that the same technical problem occurs not only in a case where the plurality of feature vectors are synthesized but also in any case where another feature vector is generated from the plurality of feature vectors.

It is an example object of the present disclosure to provide a data processing apparatus, a data processing method and a recording medium that can solve the above described technical problem. By way of example, an example object of the present disclosure is to provide a data processing apparatus, a data processing method and a recording medium that is configured to efficiently perform a learning of an apparatus that is configured to properly generate another feature vector from a plurality of feature vectors.

### Solution to Problem

A first example aspect of a data processing apparatus of the present disclosure is a data processing apparatus that is configured to generate a third feature vector from a first feature vector and a second feature vector, the data processing apparatus includes: a calculation unit that is configured to calculate, based on the first and second feature vectors, a map information that represents a distribution of a vector component having a relatively high importance of a plurality of feature vector components that are included in a fourth feature vector obtained by synthesizing the first and second feature vectors; and a generation unit that is configured to generate the third feature vector by using the fourth feature vector and the map information.

A second example aspect of a data processing apparatus of the present disclosure is a data processing apparatus that is configured to generate a third feature vector from a first feature vector and a second feature vector, the data processing apparatus includes: a calculation unit that is configured to calculate, based on the first and second feature vectors, a map information that represents a distribution of a vector component having a relatively high importance of a plurality of feature vector components that are included in the first feature vector; and a generation unit that is configured to generate the third feature vector by using the first feature vector and the map information.

A first example aspect of a data processing method of the present disclosure is a data processing method of generating a third feature vector from a first feature vector and a second feature vector, the data processing method includes: a calculation step for calculating, based on the first and second feature vectors, a map information that represents a distribution of a vector component having a relatively high importance of a plurality of feature vector components that are included in a fourth feature vector obtained by synthesizing the first and second feature vectors; and a generation step for generating the third feature vector by using the fourth feature vector and the map information.

A second example aspect of a data processing method of the present disclosure is a data processing method of generating a third feature vector from a first feature vector and a second feature vector, the data processing method includes: a calculation step for calculating, based on the first and second feature vectors, a map information that represents a distribution of a vector component having a relatively high importance of a plurality of feature vector components that are included in the first feature vector; and a generation step for generating the third feature vector by using the first feature vector and the map information.

A first example aspect of a recording medium of the present disclosure is a recording medium on which a computer program that allows a computer to execute a data processing method is recorded, wherein the data processing method is a data processing method is a data processing method of generating a third feature vector from a first feature vector and a second feature vector, the data processing method includes: a calculation step for calculating, based on the first and second feature vectors, a map information that represents a distribution of a vector component having a relatively high importance of a plurality of feature vector components that are included in a fourth feature vector obtained by synthesizing the first and second feature vectors; and a generation step for generating the third feature vector by using the fourth feature vector and the map information.

A second example aspect of a recording medium of the present disclosure is a recording medium on which a computer program that allows a computer to execute a data processing method is recorded, wherein the data processing method is a data processing method is a data processing method of generating a third feature vector from a first feature vector and a second feature vector, the data processing method includes: a calculation step for calculating, based on the first and second feature vectors, a map information that represents a distribution of a vector component having a relatively high importance of a plurality of feature vector components that are included in the first feature vector; and a generation step for generating the third feature vector by using the first feature vector and the map information.

### BRIEF DESCRIPTION OF DRAWINGS

FIG. 1 is a block diagram that illustrates a configuration of a data processing apparatus in a present example embodiment.

FIG. 2 is a block diagram that illustrates examples of a feature vector generation unit and a map calculation unit that constitute at least a part of an attention mechanism.

FIG. 3 is a flowchart that illustrates a flow of a vector arithmetic processing that is performed by the data processing apparatus in the present example embodiment.

FIG. 4 is a block diagram that illustrates a configuration of a data processing apparatus in a first modified example.

FIG. 5 is a block diagram that illustrates a configuration of a data processing apparatus in a second modified example.

FIG. 6 is a block diagram that illustrates examples of a feature vector generation unit and a map calculation unit that constitute at least a part of an attention mechanism in the second modified example.

FIG. 7 is a block diagram that illustrates a configuration of a data processing apparatus in a third modified example.

FIG. 8 is a block diagram that illustrates a configuration of a data processing apparatus in a fourth modified example.

### EXAMPLE EMBODIMENTS

Next, an example embodiment of a data processing apparatus, a data processing method and a recording medium will be described with reference to the drawings.

### (1) CONFIGURATION OF DATA PROCESSING APPARATUS 1 IN PRESENT EXAMPLE EMBODIMENT

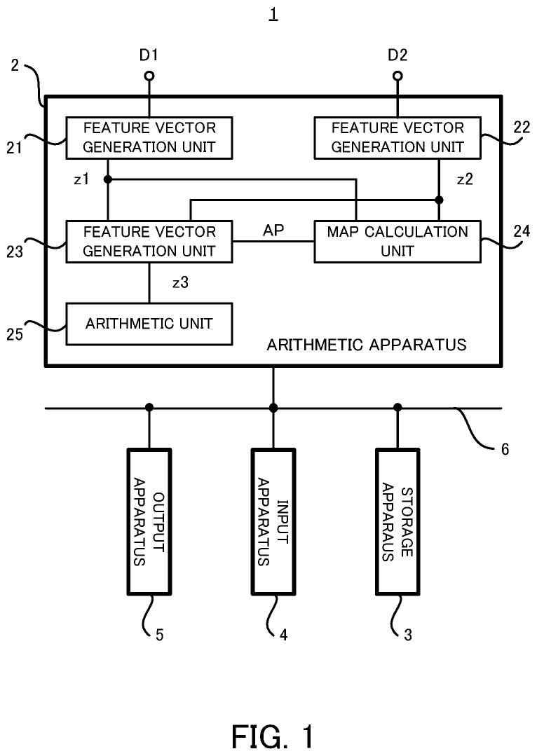

Firstly, with reference to FIG. 1, a configuration of a data processing apparatus 1 in the present example embodiment will be described. FIG. 1 is a block diagram that illustrates the configuration of the data processing apparatus 1 in the present example embodiment.

As illustrated in FIG. 1, the data processing apparatus 1 includes an arithmetic apparatus 2 and a storage apparatus 3. Furthermore, the data processing apparatus 1 may include an input apparatus 4 and an output apparatus 5. However, the data processing apparatus 1 may not include at least one of the input apparatus 4 and the output apparatus 5. The arithmetic apparatus 2, the storage apparatus 3, the input apparatus 4 and the output apparatus 5 may be interconnected through a data bus 6.

The arithmetic apparatus 2 includes at least one of a CPU (Central Processing Unit), a GPU (Graphic Processing Unit) and a FPGA (Field Programmable Gate Array), for example. The arithmetic apparatus 2 reads a computer program. For example, the arithmetic apparatus 2 may read a computer program that is stored in the storage apparatus 3. For example, the arithmetic apparatus 2 may read a computer program that is stored in a non-transitory computer-readable recording medium by using a non-illustrated recording medium reading apparatus. The arithmetic apparatus 2 may obtain (namely, download or read) a computer program from a non-illustrated apparatus that is disposed outside the data processing apparatus 1 through a non-illustrated communication apparatus. The arithmetic apparatus 2 executes the read computer program. As a result, a logical functional block for performing an operation that should be performed by the data processing apparatus 1 is implemented in the arithmetic apparatus 2. Namely, the arithmetic apparatus 2 is configured to serve as a controller for implementing the logical block for performing the operation that should be performed by the data processing apparatus 1.

In the present example embodiment, a logical functional block for performing a vector arithmetic processing using a feature vector that represents a feature of desired data is implemented in the arithmetic apparatus 2. FIG. 1 illustrates one example of the logical functional block for performing the vector arithmetic processing. As illustrated in FIG. 1, in the arithmetic apparatus 2, a feature vector generation unit 21, a feature vector generation unit 22, a feature vector generation unit 23, a map calculation unit 24 and an arithmetic unit 25 are implemented as the logical block. Note that the feature vector generation unit 21, the feature vector generation unit 22, the feature vector generation unit 23, the map calculation unit 24 and the arithmetic unit 25 are typically the logical functional blocks that are realized by a learnable learning model (for example, a learning model based on a Neural Network). In this case, the learning model defining a detail of operations of the feature vector generation unit 21, the feature vector generation unit 22, the feature vector generation unit 23, the map calculation unit 24 and the arithmetic unit 25 may be built (in other words, updated) by a learning operation using learning data that is associated with a ground truth label. However, at least one of the feature vector generation unit 21, the feature vector generation unit 22, the feature vector generation unit 23, the map calculation unit 24 and the arithmetic unit 25 may not be the logical functional block that is realized by the learning model.

The feature vector generation unit 21 is configured to generate, from data D1, a feature vector z1 representing a feature of the data D1. The feature vector generation unit 21 is configured to output the generated feature vector z1 to each of the feature vector generation unit 23 and the map calculation unit 24. The data D1 is any data that can be used by the data processing apparatus 1. For example, the data D1 may include image data, may include sound data, may include text data and may include data in another form.

The feature vector generation unit 22 is configured to generate, from data D2 that is different from the data D1, a feature vector z2 representing a feature of the data D2. The feature vector generation unit 22 is configured to output the generated feature vector z2 to each of the feature vector generation unit 23 and the map calculation unit 24. The data D2 is any data that can be used by the data processing apparatus 1. For example, the data D2 may include image data, may include sound data, may include text data and may include data in another form.

The feature vector generation unit 23 is configured to generate a feature vector z3 from the feature vectors z1 and z2. Specifically, the feature vector generation unit 23 firstly generates a feature vector z4 by synthesizing the feature vectors z1 and z2. For example, the feature vector generation unit 23 may generate the feature vector z4 by synthesizing the feature vectors z1 and z2 along a channel direction (namely, by performing what we call a concatenate calculation). In this case, the (N1+N2)-dimensional feature vector z4 may be generated from the N1-dimensional (wherein, N1 is an integer that is equal to or larger than 1) feature vector z1 and the N2-dimensional (wherein, N2 is an integer that is equal to or larger than 1) feature vector z2. Then, the feature vector generation unit 23 generate the feature vector z3 by using the feature vector z4 and a map information AP calculated by a below described map calculation unit 24. Specifically, the feature vector generation unit 23 generate the feature vector z3 by adding, to the feature vector z4, a feature vector z4×AP that is obtained by multiplying the feature vector z4 by the map information AP. Namely, the feature vector generation unit 23 generate the feature vector z3 by using a relational equation of z3=z4×(1+AP).

The map calculation unit 24 is configured to calculate the map information AP based on the feature vectors z1 and z2. The map information AP represents a distribution of a vector component having a relatively high importance of a plurality of vector components included in the feature vector z4. In other words, the map information AP represents a distribution of a vector component, to which an attention should be paid, of the plurality of vector components included in the feature vector z4. In this case, the map information AP may be regarded to represent a weight of each of the plurality of vector components included in the feature vector z4. Especially, the map information AP may represent a distribution of a vector component, which has a relatively high importance for generating the feature vector z3, of the plurality of vector components included in the feature vector z4. Especially, the map information AP may represent a distribution of a vector component, to which the attention should be paid for generating the feature vector z3, of the plurality of vector components included in the feature vector z4.

Note that the vector component which has the relatively high importance for generating the feature vector z3 (namely, the vector component to which the attention should be paid for generating the feature vector z3) may mean a vector component that contributes relatively largely to an accuracy of an arithmetic processing performed by the below described arithmetic unit 25. Namely, the vector component which has the relatively high importance for generating the feature vector z3 may mean a vector component that contributes to an increase of the accuracy of the arithmetic processing performed by the below described arithmetic unit 25 more largely than another vector component.

An method using an attention mechanism is one example of a method of calculating the distribution of the vector component to which the attention should be paid. In this case, the map calculation unit 24 may be regarded to calculate the map information AP by using the attention mechanism that calculates the map information AP as a weight. In other words, the map calculation unit 24 may be regarded to constitute at least a part of the attention mechanism that calculates the map information AP as the weight. Incidentally, when the map information AP is calculated by using the attention mechanism, the map information AP may be referred to as an attention map. However, the map calculation unit 24 may calculate the map information AP without using the attention mechanism.

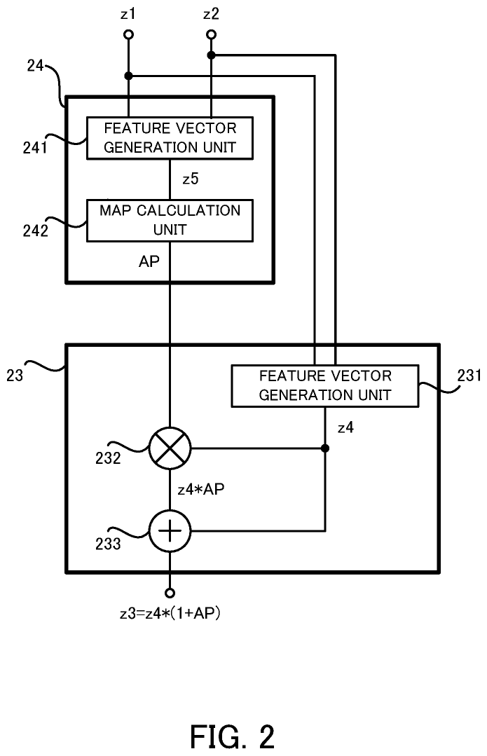

FIG. 2 illustrates one example of the map calculation unit 24 that constitutes at least a part of the attention mechanism. As illustrated in FIG. 2, the map calculation unit 24 may include a feature vector generation unit 241 and a map calculation unit 242. The feature vector generation unit 241 is configured to generate a feature vector z5 by synthesizing the feature vectors z1 and z2. The feature vector z5 generated by the feature vector generation unit 241 may be a vector that is same as the feature vector z4 generated by the above described feature vector generation unit 23. In this case, the feature vector generation unit 241 may generate the feature vector z5 by synthesizing the feature vectors z1 and z2 along the channel direction (namely, by performing what we call the concatenate calculation), as with the feature vector generation unit 23. The map calculation unit 242 is configured to calculate the map information AP based on the feature vector z5. Specifically, the map calculation unit 242 may calculate the map information AP by using the feature vector z5 as a key and a query in the attention mechanism. Alternatively, the map calculation unit 242 may generate the key in the attention mechanism by performing a first processing (for example, a first 1×1 convolution processing) on the feature vector z5, and may generate the query in the attention mechanism by performing a first processing (for example, a second 1×1 convolution processing) on the feature vector z5. In both cases, it can be said that the map calculation unit 24 constitutes at least a part of a self-attention mechanism that uses the key and the query based on the same input in an example illustrated in FIG. 2. Namely, it can be said that the map calculation unit 24 generates the map information AP by using the self-attention mechanism. The map calculation unit 242 may calculate the map information AP by using any method of calculating the weight from the key and the query in the attention mechanism. For example, the map calculation unit 242 may calculate, as the map information AP, a matrix sum of the key and the query. For example, the map calculation unit 242 may calculate, as the map information AP, a matrix product of the key and the query.

The generated map information AP is a matrix (or a vector) including, as an element, a weight representing the distribution of the vector component to which the attention should be paid. In this case, the map calculation unit 24 may calculate the normalized map information AP. Namely, the map calculation unit 24 may normalize the calculated map information AP. For example, the map calculation unit 24 may normalize the map information AP by using a sigmoid function. As a result, the map information AP is normalized so that each element of the map information AP is a value between 0 and 1. Alternatively, for example, the map calculation unit 24 may normalize the map information AP by using a Softmax function. As a result, the map information AP is normalized so that a total sum of the element in each of each row and each column of the map information AP is 1.

When the map calculation unit 24 constitutes at least a part of the attention mechanism, the feature vector generation unit 23 may also be regarded to calculate the feature vector z3 by using the attention mechanism that performs a calculation using the map information AP as the weight. In other words, the feature vector generation unit 23 may also be regarded to constitute at least a part of the attention mechanism that performs the calculation using the map information AP as the weight. However, the feature vector generation unit 23 may calculate the feature vector z3 without using the attention mechanism.

FIG. 2 illustrates one example of the feature vector generation unit 23 that constitutes at least a part of the attention mechanism. As illustrated in FIG. 2, the feature vector generation unit 23 may include a feature vector generation unit 231, a multiplication unit 232 and an addition unit 233. The feature vector generation unit 231 is configured to generate the feature vector z4 by synthesizing the feature vectors z1 and z2. Alternatively, the feature vector generation unit 231 may be configured to generate the feature vector z4 by synthesizing the feature vectors z1 and z2 and perform a third processing (for example, a third 1×1 convolution processing) on the feature vector z4. The feature vector generation unit 231 is configured to output the generated feature vector z4 (alternatively, the feature vector z4 on which the third processing has been performed) to each of the multiplication unit 232 and the addition unit 233. The multiplication unit 232 is configured to calculate a matric product of the map information AP and the feature vector z4 that is outputted from the feature vector generation unit 231 (namely, generate the feature vector z4×AP). In this case, the feature vector z4 outputted from the feature vector generation unit 231 may be regarded to correspond to a value in the attention mechanism. Since the self-attention mechanism is used in the example illustrated in FIG. 2 as described above, the value is also a vector based on the same input as the key and the query. The addition unit 233 is configured to generate the feature vector z3 (=z4×(1+AP)) by adding the feature vector z4×AP to the feature vector z4 outputted from the feature vector generation unit 231. However, the feature vector generation unit 23 may not include the addition unit 233. In this case, the feature vector z4×AP outputted from the multiplication unit 232 may be used as the feature vector z3.

Note that the feature vector generation unit 23 may obtain the feature vector z5 from the map calculation unit 24 and may use the obtained feature vector z5 as the feature vector z4, in addition to or instead of generating the feature vector z4 by using the feature vector generation unit 231. When the feature vector generation unit 23 obtains the feature vector z5 as the feature vector z4 from the map calculation unit 24, the feature vector generation unit 23 may not include the feature vector generation unit 231.

Again in FIG. 1, the arithmetic unit 25 is configured to perform a desired arithmetic processing using the feature vector z3 generated by the feature vector generation unit 23. For example, when image data that represents an image including a person is used as the data D1 and sound data that represents a word outputted from the person included in the image is used as the data D2, the feature vector z3 may represents a feature related to a face of the person and a feature related to the word of the person. In this case, the arithmetic unit 25 may perform the arithmetic processing for estimating an emotion of the person included in the image based on the feature vector z3. The arithmetic unit 25 may perform the arithmetic processing for adding a caption (namely, a subtitle) representing the word of the person to the image based on the feature vector z3.

The storage apparatus 3 is configured to store a desired data. For example, the storage apparatus 3 may temporarily store the computer program that is executed by the arithmetic apparatus 2. The storage apparatus 3 may temporarily store a data that is temporarily used by the arithmetic apparatus 2 when the arithmetic apparatus 2 executes the computer program. The storage apparatus 3 may store a data that is stored for a long term by the data processing apparatus 1. Note that the storage apparatus 3 may include at least one of a RAM (Random Access Memory), a ROM (Read Only Memory), a hard disk apparatus, a magneto-optical disc, a SSD (Solid State Drive) and a disk array apparatus. Namely, the storage apparatus 3 may include a non-transitory recording medium.

The input apparatus 4 is an apparatus that receives an input of an information from an outside of the data processing apparatus 1 to the data processing apparatus 1.

The output apparatus 5 is an apparatus that outputs an information to an outside of the data processing apparatus 1. For example, the output apparatus 5 may output an information relating to the vector arithmetic processing performed by the data processing apparatus 1.

### (2) FLOW OF VECTOR ARITHMETIC PROCESSING PERFORMED BY DATA PROCESSING APPARATUS 1

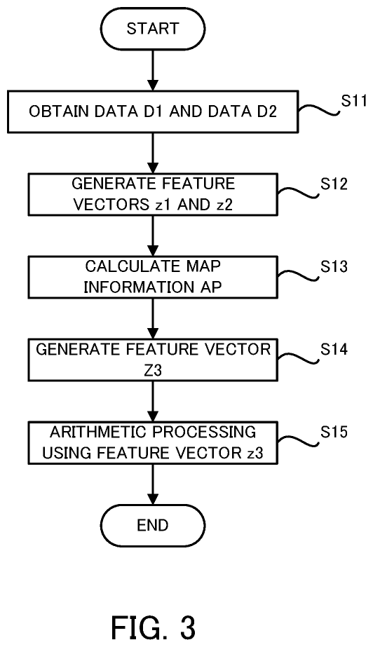

Next, with reference to FIG. 3, a flow of the vector arithmetic processing performed by the data processing apparatus 1 in the present example embodiment will be described. FIG. 3 is a flowchart that illustrates the flow of the vector arithmetic processing performed by the data processing apparatus 1 in the present example embodiment

As illustrated in FIG. 3, the feature vector generation unit 21 obtains the data D1 (a step S11). Moreover, the feature vector generation unit 21 obtains the data D2 (the step S11). Then, the feature vector generation unit 21 generates the feature vector z1 from the data D1 obtained at the step S11 (a step S12). Moreover, the feature vector generation unit 21 generates the feature vector z2 from the data D2 obtained at the step S11 (the step S12).

Then, the map calculation unit 24 calculates the map information AP based on the feature vectors z1 and z2 generated at the step S12 (a step S13). Note that a method of calculating the map information AP is already described, and thus, a detailed description thereof is omitted here.

Then, the feature vector generation unit 23 generates the feature vector z3 based on the feature vectors z1 and z2 generated at the step S12 and the map information AP calculated at the step S13 (a step S14). Note that a method of generating the feature vector z3 based on the map information AP is already described, and thus, a detailed description thereof is omitted here.

Then, the arithmetic unit 25 performs the desired arithmetic processing using the feature vector z3 generated at the step S14 (a step S15).

### (3) TECHNICAL EFFECT OF DATA PROCESSING APPARATUS 1

As described above, in the present example embodiment, the data processing apparatus 1 is capable of properly generating the feature vector z3 by using the feature vectors z1 and z2. Specifically, the data processing apparatus 1 is capable of generating the feature vector z3 by using not only the feature vectors z1 and z2 but also the map information AP. As a result, the feature vector z3 is a feature vector in which the vector component having the relatively high importance is emphasized more than the vector component having the relatively low importance, compared to the feature vector z4 that is generated by simply synthesizing the feature vectors z1 and z2. Namely, the data processing apparatus 1 is capable of generating, as the feature vector z3, a feature vector which is obtained by synthesizing the feature vectors z1 and z2 and in which the vector component having the relatively high importance is emphasized more than the vector component having the relatively low importance. Thus, the accuracy of the arithmetic processing which the arithmetic unit 25 performs by using the feature vector z3 is higher than the accuracy of the arithmetic processing which the arithmetic unit 25 performs by using the feature vector z4.

Especially, when the content of the data D1 and the data D2 changes, the content of the feature vectors z1 and z2 also changes. As a result, when the content of the data D1 and the data D2 changes, the content of the map information AP calculated based on the feature vectors z1 and z2 also changes. Namely, it can be said that the map calculation unit 24 changes the map information AP based on the content of the data D1 and the data D2. Thus, it can be said that the feature vector generation unit 23 that generates the feature vector z3 based on the map information AP changes, based on the content of the data D1 and the data D2, a method of generating the feature vector z3. Thus, it can be said that the feature vector z3 generated by a generation method that is changed based on the content of the data D1 and the data D2 represents the features of the data D1 and the data D2 (especially, the feature that is desired to be extracted for a processing that is definitely desired to be realized by using the data D1 and the data D2) more properly, compared to the feature vector z4 generated by a generation method that is not changed based on the content of the data D1 and the data D2. As a result, the accuracy of the arithmetic processing which the arithmetic unit 25 performs by using the feature vector z3 is higher than the accuracy of the arithmetic processing which the arithmetic unit 25 performs by using the feature vector z4.

### (4) MODIFIED EXAMPLE

### (4-1) First Modified Example

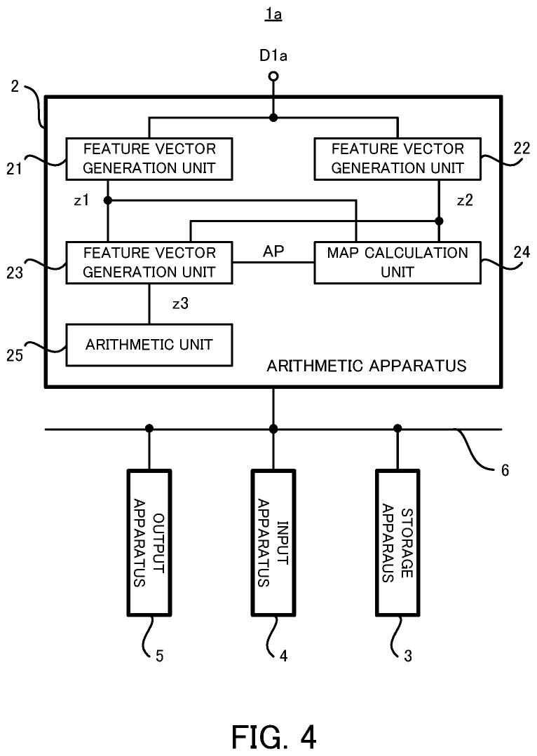

Firstly, with reference to FIG. 4, a data processing apparatus 1a in a first modified example will be described. FIG. 4 is a block diagram that illustrates a configuration of the data processing apparatus 1a in the first modified example.

As illustrated in FIG. 4, the data processing apparatus 1a in the first modified example is different from the above described data processing apparatus 1 in that the feature vector generation units 21 and 22 generate the feature vectors z1 and z2, respectively, from same data D1a. Another feature of the data processing apparatus 1a may be same as another feature of the data processing apparatus 1.

The feature vector generation unit 21 generate, from the data D1a, the feature vector z1 that represents a first feature of the data D1a. On the other hand, the feature vector generation unit 22 generate, from the data D1a, the feature vector z1 that represents a second feature of the data D1a that is different from the first feature. For example, when the image data that represents the image including the person is used as the data D1a, the feature vector generation unit 21 may generate the feature vector z1 that represents the feature related to a gaze direction of the person and the feature vector generation unit 22 may generate the feature vector z2 that represents the feature related to a face direction of the person

The data processing apparatus 1a in the first modified example is capable of achieving an effect that is same as the effect achievable by the above described data processing apparatus 1.

### (4-2) Second Modified Example

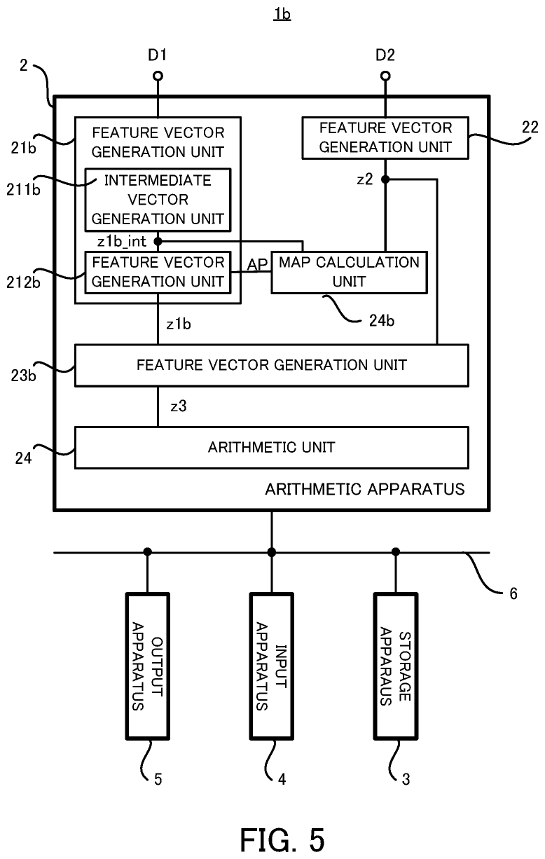

Next, with reference to FIG. 5, a data processing apparatus 1b in a second modified example will be described. FIG. 5 is a block diagram that illustrates a configuration of the data processing apparatus 1b in the second modified example.

As illustrated in FIG. 5, the data processing apparatus 1b in the second modified example is different from the above described data processing apparatus 1 in that it includes a feature vector generation unit 21b, a feature vector generation unit 23b and a map calculation unit 24b instead of the feature vector generation unit 21, the feature vector generation unit 23b and the map calculation unit 24. Another feature of the data processing apparatus 1b may be same as another feature of the data processing apparatus 1.

The feature vector generation unit 21b is different from the feature vector generation unit 21 in that it includes an intermediate vector generation unit 211b and a feature vector generation unit 212b. Another feature of the feature vector generation unit 21b may be same as another feature of the feature vector generation unit 21. The intermediate vector generation unit 211b is configured to generate, from the data D1, an intermediate vector z1b_int that is used to generate the feature vector z1. Note that the intermediate vector z1b_int may be regarded to be a vector representing the feature of the data D1, as with the feature vector z1. The feature vector generation unit 212b is configured to generate the feature vector z1 from the intermediate vector z1b_int. Especially, the feature vector generation unit 212b is configured to generate the feature vector z1 by using not only the intermediate vector z1b_int but also the map information AP calculated by the map calculation unit 24b. In the below described description, the feature vector z1 in the second modified example generated by using the map information AP is referred to as a “feature vector z1b” to distinguish it from the feature vector z1 generated without using the map information AP.

The feature vector generation unit 23b is different from the above described feature vector generation unit 23, which is configured to generate the feature vector z3 from the feature vector z1 generated without using the map information AP and the feature vector z2 in that it is configured to generate the feature vector z3 from the feature vector z1b generated by using the map information AP and the feature vector z2. Furthermore, the feature vector generation unit 23b is different from the above described feature vector generation unit 23, which is configured to use the map information AP to generate the feature vector z3 in that it may not configured to use the map information AP to generate the feature vector z3. When the feature vector z3 is generated without using the map information AP, the feature vector generation unit 23b may generate the feature vector z3 by synthesizing the feature vectors z1b and z2, for example. For example, the feature vector generation unit 23b may generate the feature vector z3 by synthesizing the feature vectors z1b and z2 along the channel direction (namely, by performing what we call the concatenate calculation). Another feature of the feature vector generation unit 23b may be same as another feature of the feature vector generation unit 23.

The map calculation unit 24b is different from the above described map calculation unit 24, which is configured to calculate the map information AP based on the feature vectors z1 and z2, in that it is configured to calculate the map information AP based on the intermediate vector z1b_int and the feature vector z2. Namely, the map calculation unit 24b is different from the above described map calculation unit 24 in that it is configured to calculate the map information AP by using the intermediate vector z1b_int that is generated in the process of generating the feature vector z1. Another feature of the map calculation unit 24b may be same as another feature of the map calculation unit 24.

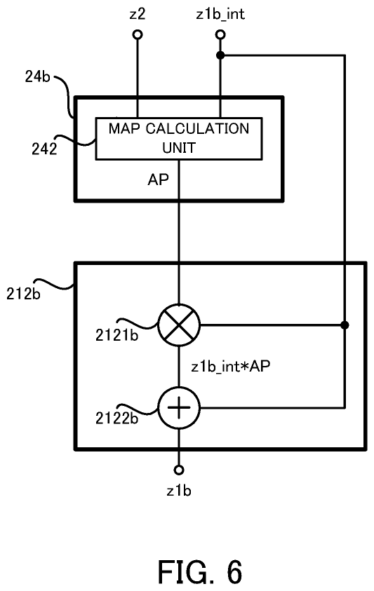

FIG. 6 illustrates one example of the map calculation unit 24b in the second modified example. As illustrated in FIG. 6, the map calculation unit 24b may include the map calculation unit 242, as with the above described map calculation unit 24. The intermediate vector z1b_int and the feature vector z2 are inputted to the map calculation unit 242. The map calculation unit 242 may calculate the map information AP by using the intermediate vector z1b_int as the key in the attention mechanism and using the feature vector z2 as the query in the attention mechanism. Alternatively, the map calculation unit 242 may generate the key in the attention mechanism by performing a fourth processing (for example, a fourth 1×1 convolution processing) on the intermediate vector z1b_int, and may generate the query in the attention mechanism by performing a fifth processing (for example, a fifth 1×1 convolution processing) on the feature vector z2. In both cases, it can be said that the map calculation unit 24 constitutes at least a part of a source-target attention mechanism that uses the key and the query based on the different inputs in an example illustrated in FIG. 6. Namely, it can be said that the map calculation unit 24 generates the map information AP by using the source-target attention mechanism. Note that the map calculation unit 242 may calculate the map information AP by using any method of calculating the weight from the key and the query in the attention mechanism even in the second modified example.

As described above, the map calculation unit 24b constitutes at least a part of the attention mechanism even in the second modified example. Moreover, when the map calculation unit 24b constitutes at least a part of the attention mechanism, the feature vector generation unit 21b (especially, the feature vector generation unit 212b) that generates the feature vector z1b by using the map information AP may also be regarded to calculate the feature vector z1b by using the attention mechanism that performs the calculation using the map information AP as the weight. In other words, the feature vector generation unit 21b (especially, the feature vector generation unit 212b) may also be regarded to constitute at least a part of the attention mechanism that performs the calculation using the map information AP as the weight.

FIG. 6 illustrates one example of the feature vector generation unit 21b (especially, the feature vector generation unit 212b) that constitutes at least a part of the attention mechanism. As illustrated in FIG. 6, the feature vector generation unit 212b may include a multiplication unit 2121b and an addition unit 2122b. The multiplication unit 2121b is configured to generate a feature vector z1b_int×AP by multiplying the intermediate vector z1b_int that is generated by the intermediate vector generation unit 211b by the map information AP. Alternatively, the multiplication unit 2121b may perform a sixth processing (for example, a sixth 1×1 convolution processing) on the intermediate vector z1b_int, and may generate the feature vector z1b_int×AP by multiplying the intermediate vector z1b_int on which the sixth processing has been performed by the map information AP. In this case, the intermediate vector z1b_int inputted to the multiplication unit 2121b may be regarded to correspond to a value in the attention mechanism. Since the source-target attention mechanism is used in the example illustrated in FIG. 6 as described above, the value is a vector based on the same input (what we call a source) as the key and the query is a vector based on the different input (what we call a target) from the source. The addition unit 2122n is configured to generate the feature vector z1b (=z1b_int×(1+AP)) by adding the feature vector z1b_int×AP to the intermediate vector z1b_int generated by the intermediate vector generation unit 211b. However, the feature vector generation unit 212b may not include the addition unit 2122b. In this case, the feature vector z1b_int×AP outputted from the multiplication unit 2121b may be used as the feature vector z1b.

As described above, in the second modified example, the map information AP is used in the process of generating the feature vector z1b. specifically, the map information AP is generated from the feature vector z2 and the intermediate vector z1b_int that is generated in the process of generating the intermediate vector z1b. In this case, the map information AP substantially represents a distribution of a vector component having a relatively high importance of a plurality of vector components included in the feature vector z1b_int. Namely, the map information AP represents a distribution of a vector component, which has a relatively high importance for generating the feature vector z1b, of the plurality of vector components included in the intermediate vector z1b_int. Furthermore, since the feature vector z1b is used to generate the feature vector z3, it can be said that the map information AP represents a distribution of a vector component, which has a relatively high importance for generating the feature vector z3, of the plurality of vector components included in the intermediate vector z1b_int. Thus, it can be said that the feature vector z3 generated from the feature vector z1b, which is generated by using the map information AP, also represents the features of the data D1 and the data D2 more properly, as with the above described feature vector z3 generated by using the map information AP. Thus, the data processing apparatus 1b in the second modified example is capable of achieving an effect that is same as the effect achievable by the above described data processing apparatus 1.

### (4-3) Third Modified Example

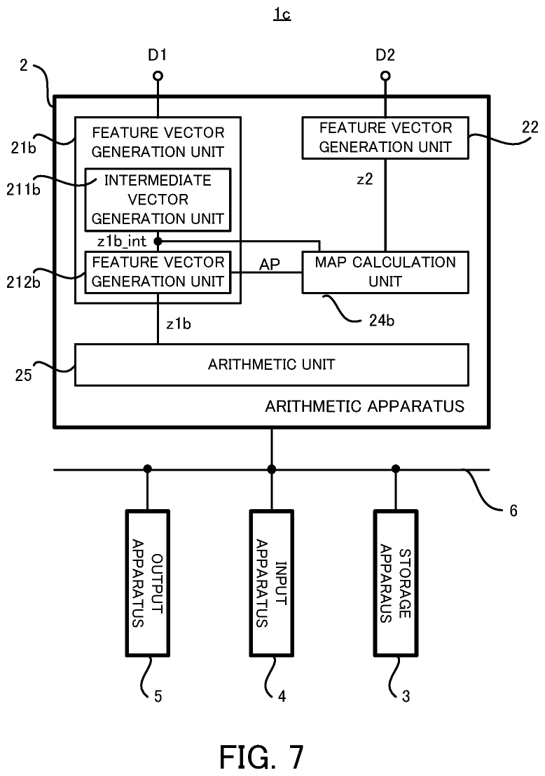

Next, with reference to FIG. 7, a data processing apparatus 1c in a third modified example will be described. FIG. 7 is a block diagram that illustrates a configuration of the data processing apparatus 1c in the third modified example.

As illustrated in FIG. 7, the data processing apparatus 1c in the third modified example is different from the above described data processing apparatus 1b in the second modified example in that it may not include the feature vector generation unit 23b. Furthermore, the data processing apparatus 1c is different from the data processing apparatus 1b in which the arithmetic unit 25 performs the arithmetic processing using the feature vector z3, in that the arithmetic unit 25 performs the arithmetic processing using the feature vector z1b. Another feature of the data processing apparatus 1c may be same as another feature of the data processing apparatus 1b.

As described above, the feature vector z1b is generated by using the map information AP that is calculated based on the intermediate vector z1b_int and the feature vector z2. Thus, the feature vector z1b itself represents not only the feature of the data D1 but also the feature of the data D2 to some extent. Thus, the data processing apparatus 1c in the third modified example is capable of achieving an effect that is same as the effect achievable by the above described data processing apparatus 1b in the second modified example. However, it is preferable that the arithmetic unit 25 performs the arithmetic processing by using the feature vector z3 generated from the feature vector z1b and the feature vector z2 as described in the second modified example, instead of the feature vector z1b, from the viewpoint of prioritizing that the arithmetic unit 25 performs the arithmetic processing by using the feature vector that represents the feature of the data D2 more properly.

### (4-4) Fourth Modified Example

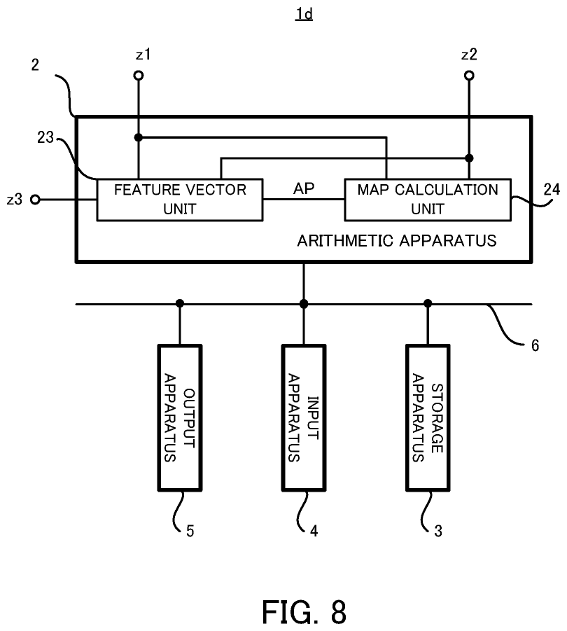

Next, with reference to FIG. 8, a data processing apparatus 1d in a fourth modified example will be described. FIG. 8 is a block diagram that illustrates a configuration of the data processing apparatus 1d in the fourth modified example.

As illustrated in FIG. 8, the data processing apparatus 1d in the fourth modified example is different from the above described data processing apparatus 1 in that it may not include at least one of the feature vector generation unit 21, the feature vector generation unit 22 and the arithmetic unit 25. In an example illustrated in FIG. 8, the data processing apparatus 1d does not include all of the feature vector generation unit 21, the feature vector generation unit 22 and the arithmetic unit 25. Another feature of the data processing apparatus 1d may be same as another feature of the data processing apparatus 1.

When the data processing apparatus 1d does not include the feature vector generation unit 21, each of the feature vector generation unit 23 and the map calculation unit 24 may obtain the feature vector z1 from an outside of the data processing apparatus 1d. When the data processing apparatus 1d does not include the feature vector generation unit 22, each of the feature vector generation unit 23 and the map calculation unit 24 may obtain the feature vector z2 from an outside of the data processing apparatus 1d. When the data processing apparatus 1d does not include the arithmetic unit 25, the feature vector generation unit 23 may output the generated feature vector z3 to an outside of the data processing apparatus 1d.

### (4-5) Other Modified Example

In the above described description, the data processing apparatus 1 generates the feature vector z3 from two feature vectors (specifically, the feature vectors z1 and z2). However, the data processing apparatus 1 may generate the feature vector z3 from three or more feature vectors in this case, the data processing apparatus 1 may include three or more feature vector generation units that is configured to generate three or more feature vectors, respectively, a map calculation unit that is configured to generate the map information AP by using the three or more feature vectors and a feature vector generation unit that is configured to generate another feature vector by using the three or more feature vectors and the map information AP.

### (5) SUPPLEMENTARY NOTE

With respect to the example embodiments described above, the following Supplementary Notes will be further disclosed.

### [Supplementary Note 1]

1. A data processing apparatus that is configured to generate a third feature vector (z3) from a first feature vector (z1) and a second feature vector (z2),

the data processing apparatus including:

a calculation unit (24) that is configured to calculate, based on the first and second feature vectors, a map information (AP) that represents a distribution of a vector component having a relatively high importance of a plurality of feature vector components that are included in a fourth feature vector (z4) obtained by synthesizing the first and second feature vectors; and

a generation unit (23) that is configured to generate the third feature vector (z3=z4*(1+AP) or z4*AP) by using the fourth feature vector and the map information.

### [Supplementary Note 2]

The data processing apparatus according to Supplementary Note 1, wherein

the generation unit (23) is configured to:

generate a fifth feature vector (z4*AP) by multiplying the fourth feature vector (z4) by the map information (AP) as a weight; and

generate the third feature vector (z3=z4*(1+AP)) by adding the fifth feature vector (z4*AP) to the fourth feature vector (z4).

### [Supplementary Note 3]

A data processing apparatus that is configured to generate a third feature vector (z1b) from a first feature vector (z1b_int) and a second feature vector (z2),

the data processing apparatus including:

a calculation unit (24) that is configured to calculate, based on the first and second feature vectors, a map information (AP) that represents a distribution of a vector component having a relatively high importance of a plurality of feature vector components that are included in the first feature vector (z1b_int); and

a generation unit (212b) that is configured to generate the third feature vector (z1b) by using the first feature vector and the map information.

### [Supplementary Note 4]

The data processing apparatus according to Supplementary Note 3, wherein

the generation unit (212b) is configured to:

generate a fourth feature vector (z1b_int*AP) by multiplying the first feature vector (z1b_int) by the map information (AP) as a weight; and

generate the third feature vector (z1b) by adding the fourth feature vector (z1b_int*AP) to the first feature vector (z1b_int).

### [Supplementary Note 5]

The data processing apparatus according to Supplementary Note 3 or 4, wherein

the generation unit (212b) is configured to generate a fifth feature vector (z3) by synthesizing the third feature vector (z1b) and the second feature vector (z2).

### [Supplementary Note 6]

6. The data processing apparatus according to any one of Supplementary Notes 1 to 5, wherein

the calculation unit is configured to calculate the map information by using an attention mechanism that uses the map information as a weight.

### [Supplementary Note 7]

The data processing apparatus according to any one of Supplementary Notes 1 to 6, wherein

the generation unit is configured to generate the third feature vector by using an attention mechanism that uses the map information as a weight.

### [Supplementary Note 8]

The data processing apparatus according to any one of Supplementary Notes 1 to 7 including:

a first vector generation unit that is configured to generate, from first data, the first feature vector that represents a feature of the first data; and

a second vector generation unit that is configured to generate, from second data that is different from the first data, the second feature vector that represents a feature of the second data.

### [Supplementary Note 9]

The data processing apparatus according to any one of Supplementary Notes 1 to 7 comprising:

a first vector generation unit that is configured to generate, from first data, the first feature vector that represents a first feature of the first data; and

a second vector generation unit that is configured to generate, from the first data, the second feature vector that represents a second feature of the first data that is different from the first feature.

### [Supplementary Note 10]

10. The data processing apparatus according to any one of Supplementary Notes 1 to 9, wherein

the calculation unit is configured to calculate the map information by using a Neural Network.

### [Supplementary Note 11]

The data processing apparatus according to any one of Supplementary Notes 1 to 10, wherein

the generation unit is configured to generate the third feature vector by using a Neural Network.

### [Supplementary Note 12]

A data processing method of generating a third feature vector (z3) from a first feature vector (z1) and a second feature vector (z2),

the data processing method including:

a calculation step for calculating, based on the first and second feature vectors, a map information (AP) that represents a distribution of a vector component having a relatively high importance of a plurality of feature vector components that are included in a fourth feature vector (z4) obtained by synthesizing the first and second feature vectors; and

a generation step for generating the third feature vector (z3=z4*(1+AP) or z4*AP) by using the fourth feature vector and the map information.

### [Supplementary Note 13]

A data processing method of generating a third feature vector (z1b) from a first feature vector (z1b_int) and a second feature vector (z2),

the data processing method comprising:

a calculation step for calculating, based on the first and second feature vectors, a map information (AP) that represents a distribution of a vector component having a relatively high importance of a plurality of feature vector components that are included in the first feature vector (z1b_int); and

a generation step for generating the third feature vector (z1b) by using the first feature vector and the map information.

### [Supplementary Note 14]

A recording medium on which a computer program that allows a computer to execute a data processing method is recorded,

the data processing method is a data processing method of generating a third feature vector (z3) from a first feature vector (z1) and a second feature vector (z2),

the data processing method including:

a calculation step for calculating, based on the first and second feature vectors, a map information (AP) that represents a distribution of a vector component having a relatively high importance of a plurality of feature vector components that are included in a fourth feature vector (z4) obtained by synthesizing the first and second feature vectors; and

a generation step for generating the third feature vector (z3=z4*(1+AP) or z4*AP) by using the fourth feature vector and the map information.

### [Supplementary Note 15]

A recording medium on which a computer program that allows a computer to execute a data processing method is recorded,

the data processing method is a data processing method of generating a third feature vector (z1b) from a first feature vector (z1b_int) and a second feature vector (z2),

the data processing method comprising:

a calculation step for calculating, based on the first and second feature vectors, a map information (AP) that represents a distribution of a vector component having a relatively high importance of a plurality of feature vector components that are included in the first feature vector (z1b_int); and

a generation step for generating the third feature vector (z1b) by using the first feature vector and the map information.

The present disclosure is allowed to be changed, if desired, without departing from the essence or spirit of the invention which can be read from the claims and the entire specification, and a data processing apparatus, a data processing method and a recording medium, which involve such changes, are also intended to be within the technical scope of the present disclosure.

### DESCRIPTION OF REFERENCE CODES

1 data processing apparatus
2 arithmetic apparatus
21, 22, 23 feature vector generation unit
24 map calculation unit
25 arithmetic unit
z1, z2, z3, z4 feature vector
AP map information

What is claimed is:

1. A data processing apparatus that is configured to generate a third feature vector from a first feature vector and a second feature vector,
the data processing apparatus comprising:
at least one memory configured to store instructions; and
at least one processor configured to execute the instructions to:
calculate, based on the first and second feature vectors, a map information that represents a distribution of a vector component having a relatively high importance of a plurality of feature vector components that are included in a fourth feature vector obtained by synthesizing the first and second feature vectors; and
generate the third feature vector by using the fourth feature vector and the map information.

2. The data processing apparatus according to claim 1, wherein
the at least one processor is configured to execute the instructions to:
generate a fifth feature vector by multiplying the fourth feature vector by the map information as a weight; and
generate the third feature vector by adding the fifth feature vector to the fourth feature vector.

3. A data processing apparatus that is configured to generate a third feature vector from a first feature vector and a second feature vector,
the data processing apparatus comprising:
at least one memory configured to store instructions; and
at least one processor configured to execute the instructions to:
calculate, based on the first and second feature vectors, a map information that represents a distribution of a vector component having a relatively high importance of a plurality of feature vector components that are included in the first feature vector; and
generate the third feature vector by using the first feature vector and the map information.

4. The data processing apparatus according to claim 3, wherein
the at least one processor is configured to execute the instructions to:
generate a fourth feature vector by multiplying the first feature vector by the map information as a weight; and
generate the third feature vector by adding the fourth feature vector to the first feature vector.

5. The data processing apparatus according to claim 3, wherein
the at least one processor is configured to execute the instructions to generate a fifth feature vector by synthesizing the third feature vector and the second feature vector.

6. The data processing apparatus according to claim 1, wherein
the at least one processor is configured to execute the instructions to calculate the map information by using an attention mechanism that uses the map information as a weight.

7. The data processing apparatus according to claim 1, wherein
the at least one processor is configured to execute the instructions to generate the third feature vector by using an attention mechanism that uses the map information as a weight.

8. The data processing apparatus according to claim 1, wherein
the at least one processor is configured to execute the instructions to:
generate, from first data, the first feature vector that represents a feature of the first data; and
generate, from second data that is different from the first data, the second feature vector that represents a feature of the second data.

9. The data processing apparatus according to claim 1, wherein
the at least one processor is configured to execute the instructions to
generate, from first data, the first feature vector that represents a first feature of the first data; and
generate, from the first data, the second feature vector that represents a second feature of the first data that is different from the first feature.

10. The data processing apparatus according to claim 1, wherein
the at least one processor is configured to execute the instructions to calculate the map information by using a Neural Network.

11. The data processing apparatus according to claim 1, wherein
the at least one processor is configured to execute the instructions to generate the third feature vector by using a Neural Network.

12. (canceled)

13. (canceled)

14. A non-transitory recording medium on which a computer program that allows a computer to execute a data processing method is recorded,
the data processing method is a data processing method of generating a third feature vector from a first feature vector and a second feature vector,
the data processing method comprising:
calculating, based on the first and second feature vectors, a map information that represents a distribution of a vector component having a relatively high importance of a plurality of feature vector components that are included in a fourth feature vector obtained by synthesizing the first and second feature vectors; and
generating the third feature vector by using the fourth feature vector and the map information.

15. (canceled)
